(19) United States
(12) Patent Application Publication
(10) Pub. No.: US 2010/0303972 A1
(43) Pub. Date: Dec. 2, 2010

(54) Method and System for Food Preparation

(76) Inventor: Siddhartha Srivastava, Mumbai (IN)

Correspondence Address: JOSEPH STECEWYCZ, P.O. BOX 1309, GROTON, MA, 01450, US

(21) Appl. No.: 12/667,218

(22) PCT Filed: Apr. 10, 2008
(86) PCT No.: PCT/IB2008/000858

§ 371 Date: Aug. 20, 2010

(30) Foreign Application Priority Data
Jun. 29, 2007 (IN) 1243/MUM/2007

(51) Int. Cl. A23L 1/01; A47J 43/04; H05B 6/80; A47J 27/00; A47J 43/28; A47J 36/00; G06F 19/00

(52) U.S. Cl. 426/233; 99/537; 99/451; 99/331; 99/342; 99/443 R; 700/112

(57) ABSTRACT

A system for preparation of high quality and healthy food by automatic means is provided. The system includes one or more sections for carrying out the one or more operations required for the preparation of food. The food is prepared using automated or semi-automated processes using one or more processing devices.

### BACKGROUND OF THE INVENTION

1. Field of the Invention

The present invention relates to a system for preparation of food and, in particular, is related to a system for preparing food with the help of one or more processing devices, based on input provided by a user.

2. Description of the Prior Art

Presently, preparation of food is mainly a manual process. Some of the steps for food preparation include, but are not limited to, cutting vegetables, adding spices and oil in the correct quantity, and heating food items. These steps require the user to perform various operations. This results in consumption of significant amount of time and labour for preparing the food.

Further, during the preparation of food, some of the operations require sound judgement of the person preparing the food. Examples of such operations include, but are not limited to, addition of salt, addition of sugar and addition of oil. Correct performance of such operations becomes an important factor in determining the overall quality and taste of food. Even a small variation from the correct quantity can significantly alter the taste of the food.

Moreover, as most of the processes are manual and require judgement in addition of various ingredients for preparation of food, it makes food preparation a specialised job. Therefore, people with no cooking expertise are unable to cook high quality meals themselves. Also, even when the recipes are available for cooking, it is not easy to follow them to perfection.

Further, people who are suffering from a health problem or who are health conscious, sometimes are unaware of the effect a food type may have on them. For example, a person suffering from diabetes should refrain from taking food with high sugar content. However, while cooking, the person would not know the adverse effect of a particular item or a particular quantity of an ingredient. Such conditions lead to a greater uncertainty for maintaining a desired healthy state of the person.

In addition, the changing lifestyle of people has left them so busy that they do not get enough time to cook for themselves. In this scenario, a person reaching home after a long day of work would like to have cooked food ready for his dinner.

In the light of the foregoing discussion, there is a need for a system for food preparation which reduces the manual effort required during the preparation of food. Further, there is a need for a system which can prepare high quality meals using a semi-automated or automated process, thereby reducing the manual judgement required during food preparation. Additionally, there is a need for a system which can be controlled remotely for food preparation and which can advise people food based on their health condition.

### SUMMARY OF THE INVENTION

Accordingly, it is an object of the present invention to provide a system for automatic preparation of food.

It is another object of the present invention to provide a system for preparation of high quality food consisting of one or more ingredients in a correct quantity.

It is yet another object of the present invention to provide a system which can advise suitable food to people based on their health condition.

It is yet another object of the present invention to provide a system which can be controlled remotely for food preparation.

The above and other objects of the present invention are achieved by providing a system for automatic preparation of food.

In accordance with an embodiment of the present invention, the system includes a one or more preparation sections, where the one or more preparation sections include a storage section, a transporting section, a cooking section, a heating section and a cleaning section. The different operations required for the preparation of food are carried out in designated sections of the system. The food is prepared using one or more ingredients, the one or more ingredients being selected based on a recipe. The storage section stores a plurality of ingredients. The transporting section selects and transports the one or more ingredients of the plurality of ingredients and semi-processed food between the various sections of the system. Further, one or more processing steps associated with the food preparation are carried out in the cooking section. Moreover, heating functions required during the preparation of the food is carried out by the heating section. The cleaning section is responsible for performing all cleaning and washing functions after the preparation of the food. Further, the system comprises a computing device, the computing device controlling the one or more preparation sections for the preparation of the food.

The present invention provides a system which is able to provide high quality food to the user. The high quality food contains the one or more ingredients in a correct quantity. Further, the process for preparation of food can be automated or semi-automated thereby facilitating preparation of high quality meals. Moreover, the user can modify the recipe according to the taste and requirements. Additionally, the user can control the system of the present invention from a remote location.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 illustrates a system for automatic preparation of food, in accordance with an embodiment of the system;

FIG. 2 illustrates a system for automatic preparation of food, in accordance with another embodiment of the invention;

FIG. 3 illustrates a computing device for automatic preparation of food, in accordance with an embodiment of the invention;

FIG. 4 illustrates a System Architecture of the computing device, in accordance with an embodiment of the present invention;

FIG. 5 illustrates an environment in which various embodiments of the invention can be practised; and

FIG. 6 is flowchart illustrating exemplary processing steps for automatic preparation of food, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail the particular system for automatic preparation of food in accordance with an embodiment of the present invention, it should be observed that the present invention resides primarily in combinations of system components related to preparation of food of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as “‘first”’ and “‘second’,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

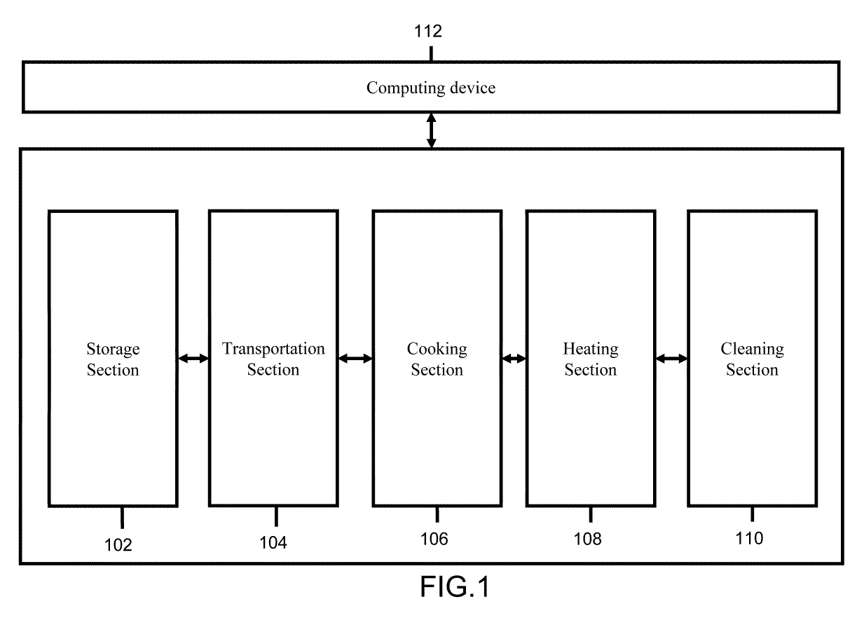

FIG. 1 illustrates a system 100 for automatic preparation of food, in accordance with an embodiment of the system. The system 100 includes one or more preparation sections, where the one or more preparation sections includes a storage section 102, a transportation section 104, a cooking section 106, a heating section 108 and a cleaning section 110. The system 100 further includes a computing device 112 for controlling the one or more preparation sections. One or more processes required for the preparation of the food takes place in designated sections of the system 100. The storage section 102 stores one or more ingredients required for the preparation of the food. The one or more ingredients are determined on the basis of recipe of the food to be prepared. Examples of the one or more ingredients include but are not limited to one or more vegetables, spices, oil, salt, sugar and the like. The transportation section 104 transports the one or more ingredients and semi-processed food between various sections of the system 100. The cooking section 106 performs one or more cooking operations on the one or more ingredients or the semi-processed food required during the preparation of the food. Examples of the one or more processing operations include, but are not limited to, at least one of a measuring operation, a cutting operation, a chopping operation, a grinding operation, a sifting operation, and a mixing operation. The cooking section 106 further performs one or more mechanical operations. Examples of the one or more mechanical operations include, but are not limited to, a cutting operation, a measuring operation, a weighing operation and a combining operation.

In accordance with an embodiment of the invention, the cooking section 106 includes a temperature check module for controlling the temperature in the cooking section during temperature based mechanical operations.

In accordance with another embodiment of the invention, the cooking section 106 includes a time check module for controlling time based mechanical operations.

In accordance with yet another embodiment of the invention, the cooking section 106 includes separate modules for performing each of the one or more cooking operations. For example, the cooking section 106 may include a mixing module for mixing the one or more ingredients.

The heating section 108 performs one or more heating functions required during the preparation of food. Examples of the one or more heating functions include, but are not limited to, a boiling operation, a frying operation, and a baking operation. The cleaning section 110 performs cleaning of the various parts of the system used during and after the preparation of the food. One or more cleaning operations such as a pre-scrubbing operation, a rinsing operation and a drying operation are performed in the cleaning section 110.

In accordance with an embodiment of the invention, each section to be cleaned is emplaced within the cleaning section 110 and exposed to pressurized water spray and cleaning soap.

The computing device 112 controls the one or more processes of the system required for the preparation of the food. Examples of the computing device 112 include, but are not limited to, a personal computer (PC), a minicomputer, a mainframe computer, a microcomputer, a telephone device and a personal digital assistant (PDA). The computing device 112 is capable of being connected to the one or more preparation sections through either one of a switched telephone connection, a cable connection and a wireless connection.

In accordance with an embodiment of the present invention, the computing device 112 includes a LCD screen mounted on the system, the LCD screen being a touch screen.

The computing device 112 controls the one or more processes of the system 100 using one or more processing devices. Examples of the one or more processing devices include, but are not limited to, microprocessors and Integrated circuits (ICs). Examples of the one or more processes controlled by the computing device 112 include, but are not limited to, determining the one or more ingredients based on the recipe, selecting the one or more ingredients based on the recipe, transferring of the one or more ingredients from the storage section 102, performing the one or more mechanical operations on the one or more ingredients, controlling the cooking operation, and notifying the user when the food is ready.

In accordance with an embodiment of the present invention, the one or more processing devices receive a sequence of steps to be performed for the preparation of the food. The sequence of steps corresponds to the one or more processes to be carried out on the one or more ingredients based on the recipe. For example, the one or more processing devices may receive instructions to identify each of the one or more ingredients for a particular recipe, controlling the selection and transfer of the one or more ingredients from the storage section 102 in a specified order using the transporting section 104. Subsequently, sending the one or more ingredients to the cooking section 106 for carrying out the one or more processing operations and cooking the food in the heating section 108 and notifying the user when the food is ready. The sequence of steps corresponds to a food processing command received by the one or more processing devices and corresponds to the recipe of the food to be prepared.

In accordance with another embodiment of the present invention, the computing device 112 is capable of transmitting and receiving information in the form of a printing operation, an email or other remote communication form, spoken command, keyboard entry, or Bluetooth, RF or other near-field communications means.

In accordance with yet another embodiment of the present invention, one or more recipes in the computing device 112 may stored by one or more means. Examples of the one or more means include, but are not limited to: installing a software code, downloading from internet, creation by the user, downloading from a database, receiving through email, and receiving through wireless means.

In accordance with an embodiment of the present invention, the one or more recipes can be modified to create a customized recipe. For example, amount of salt in the recipe can be modified according to the taste and requirements of the user.

In accordance with another embodiment of the present invention, the computing device 112 presents the user with health related information about the one or more ingredients. The health related information is stored in the computing device 112. Examples of the health related information include, but are not limited to: calorie information, nutritional value, cholesterol, sugar content, carbohydrate content and the like. Accordingly, the system 100 can help in controlling and monitoring the food intake and dietary intake of the user. The system 100 also presents the user with one or more alternative recipes having different calorie measure.

In accordance with yet another embodiment of the present invention, the system 100 includes one or more health indicator modules as an input device to the computing device 112. The one or more health indicator modules read(s) the one or more medical conditions of the user. Examples of the one or more health indicator modules include, but are not limited to, a blood-sugar or blood-alcohol tester, a blood pressure monitor, a pulse monitor, a drug or toxin measuring device, a breath analyzer, a urine analyzer, a skin electrical resistance sensor, a body thermometer and the like. Examples of the one or more medical conditions of the user include, but are not limited to: blood pressure, heart beat rate, cardio vascular disease, alcoholism or narcotics addiction, blood sugar level, hormone levels, pregnancy, stress levels and the like. The computing device 112 analyses one or medical conditions of the user on the basis of input through the one or medical input devices.

In an embodiment of the invention, the computing device 112 is capable of storing and analyzing or synthesizing historical medical measurements of this type, input either by that type of medical reading sensor, user input, or remote inputs by a user, doctor, health care provider or other health or wellness related input provider. The computing device 112 present the user with one or more food options base on the one or more medical conditions of the user. Further, the medical information can be communicated to other users such as doctors through at least one of an intranet or an internet. Moreover, the recipe is modified to adjust the calorie or sugar level of the food based on the one or more medical conditions of the user.

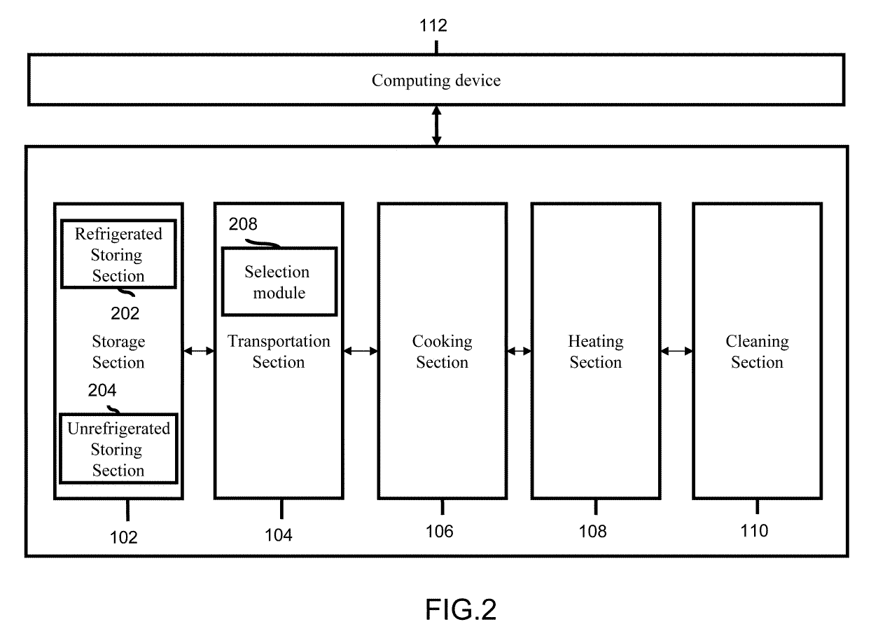

FIG. 2 illustrates the system 100 for automatic preparation of food, in accordance with another embodiment of the invention. The system 100 includes the one or more preparation sections, where the one or more preparation sections includes the storage section 102, the transportation section 104, the cooking section 106, the heating section 108 and the cleaning section 110. The system further includes the computing device 112 for controlling the one or more preparation sections. The storage section 102 includes a refrigerated storage section 202 and an unrefrigerated storage section 204. The refrigerated storage section 202 is capable of storing at least one ingredient that requires a specified preservation temperature. The transportation section 104 includes a selection module 206 for selecting the one or more ingredients from the plurality of ingredients stored in the storage section 102.

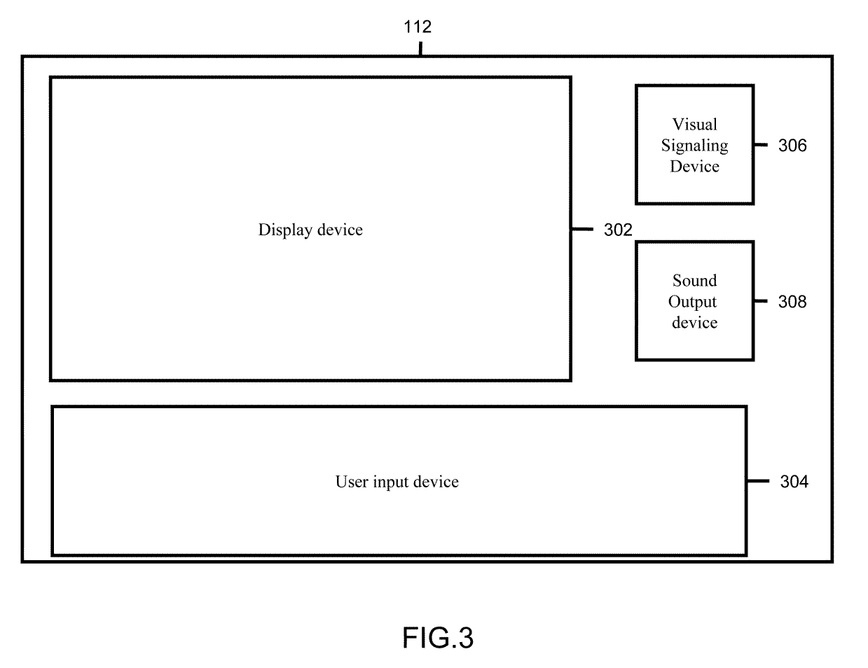

FIG. 3 illustrates the computing device 112 for automatic preparation of food, in accordance with an embodiment of the invention. The computing device 112 includes a display screen 302, a user input device 304, a visual signalling device 306 and a sound output device 308. The computing device 112 controls the one or more processes of the system 100. The computing device 112 is connected to the system 100 through either one of a switched telephone connection, a cable connection and a wireless connection. Examples of the display screen 302 include, but are not limited to, a Liquid Crystal display (LCD) screen, a thin film transistor (TFT), and a cathode ray tube (CRT) screen. Examples of the user input device 304 include, but are not limited to, a keyboard, a mouse, a microphone and a touch screen display. The visual signaling device 306 notifies the user when the food is ready, when a fault occurs or a specified set of instructions has been performed successfully. The sound output device 308 is capable of receiving voice instructions. Further, the sound output device 308 notifies the user when the food has been prepared or a fault has occurred.

In accordance with one embodiment of the present invention, the display screen 302 presents the user with one or more user interface screens. The one or more user interface screens allow the user to select the one or more processes to be performed.

In accordance with another embodiment of the present invention, the one or more user interface screens allow selection of type of food to be prepared. For example, the user can select the type of food from one or more categories. Examples of the one or more categories include, but are not limited to Italian food, Mexican food, Chinese food and the like. The user can further select a particular dish from the one or more categories. The one or more user interface screens comprise a search interface. The search interface enables the user to search one or more categories of the food and a particular dish from the one or more categories.

In accordance with yet another embodiment of the present invention, the search interface facilitates keyword based search.

In accordance with another embodiment of the present invention, one or more recipes can be created with one or more user interface screens.

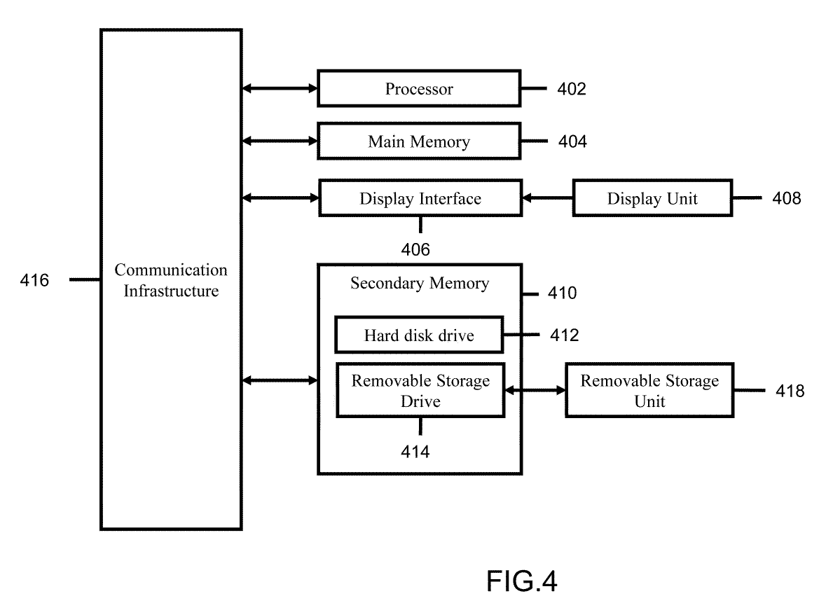

FIG. 4 shows the system architecture of the computing device 112 in accordance with an embodiment of the present invention. The computing device 112 includes a processor 402, a main memory 404, a display interface 406, a display unit 408, a secondary memory 410, a hard disk drive 412 and a removable storage drive 414. The figure further shows a communication infrastructure 416 and a removable storage unit 418. The processor 402 and the main memory 404 are connected to the communication infrastructure 416. Examples of main memory 404 include, but are not limited to, random access memory (RAM). The display interface 406 transfers data from the communication infrastructure 416 for display on the display unit 408. Further, the secondary memory 410 is also connected to the communication infrastructure 416 and includes the hard disk drive 412 and the removable storage device 414. Examples of the removable storage device 416 include, but are not limited to, a floppy disk drive, a magnetic tape drive, and an optical disc drive. Removable storage drive 414 reads or writes from removable storage unit 418. Examples of the removable storage unit 418 include, but are not limited to, a floppy disk, a magnetic tape, and an optical disk. As will be appreciated, the removable storage unit 418 includes a computer usable storage medium having stored therein at least one of a computer software and data.

According to one of the embodiments of the present invention, the secondary memory 410 includes an interface and a corresponding removable storage unit. For example, the computing device 112 includes a program cartridge and a cartridge interface, a removable memory chip such as an erasable programmable read only memory (EPROM) or a programmable read only memory.

According to another embodiment of the present invention, the computing device 112 includes a communication interface. The communication interface allows software and data to be transferred between the computing device 112 and external devices. Examples of the communication interface include, but are not limited to, a modem, a network interface such as an Ethernet card, a communication port, and a Personal Computer Memory Card International Association (PCMCIA) slot and card. The software and data transferred through the communication interface are in the form of one or more signals. Examples of the one or more signals include, but are not limited to, electronic, electromagnetic, optical and other signals capable of being received by the communication interface. The one or more signals are provided to the communication interface through a communications path. The communication path carries the one or more signals and are implemented using either one of wire or cable, fiber optics, a telephone line, a cellular link, a RF or IR link and/or other communications channels.

In this document, the terms “computer program medium” and “computer usable medium” are used to refer generally to media such as the removable storage drive 414, a hard disk installed in the hard disk drive 412, and one or more signals. The computer program products provide software to computing device 112.

One or more computer programs (also referred to as computer control logic) are stored in the main memory 404 and/or the secondary memory 410. The one or more computer programs may also be received through the communications interface. The one or more computer programs, when executed, enable the computing device 112 to perform the features of the present invention, as discussed herein. In particular, the one or more computer programs, when executed, enable the processor 404 to perform the features of the present invention. Accordingly, such computer programs represent controllers of the computing device 112.

According to an embodiment of the present invention, the present invention is implemented using one or more computer programs, the one or more computer programs being stored in a computer program product and loaded into the computing device 112 using the removable storage drive 414, the hard drive 412, or the communication infrastructure 416. The control logic (software), when executed by the processor 402, causes the processor 402 to perform the functions of the invention as described herein.

According to another embodiment of the present invention, the present invention is implemented primarily in hardware using hardware components such as application specific integrated circuits (ASICs). Implementation of the hardware state machine so as to perform the functions described herein will be apparent to persons skilled in the relevant art(s).

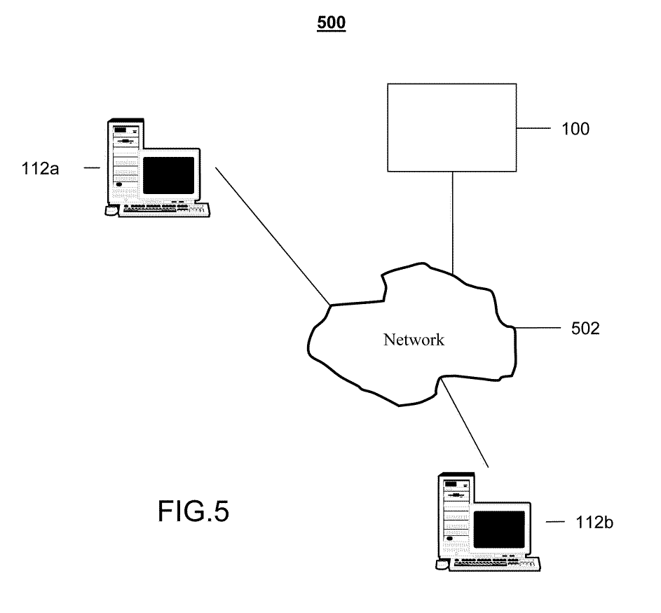

FIG. 5 illustrates an environment 500 in which various embodiments of the invention may be practised. Environment 500 includes the system 100, one or more computing devices 112a and 112b, hereinafter collectively referred to as the computing device 112 and a network 502. The system 100 is connected to the computing device 112 through the network 502. Examples of the network 502 include, but are not limited to, at least one of internet, intranet, WiFi, Bluetooth, Infrared, WiMAX, Local Area Network (LAN), GPRS, EDGE, and Virtual Private network (VPN).

According to one of the embodiments of the present invention, the network 502 is a conglomeration of connected intranets.

According to another embodiment of the present invention, the network 502 is IPV6 compatible internet.

The computing device 112 can perform one or more operations on the system 100 through the internet 502. Examples of the one or more operation include, receiving information, transmitting information and sending instruction to the system 100 and the like. The computing device 112 is capable of controlling the system 100 through the network 502.

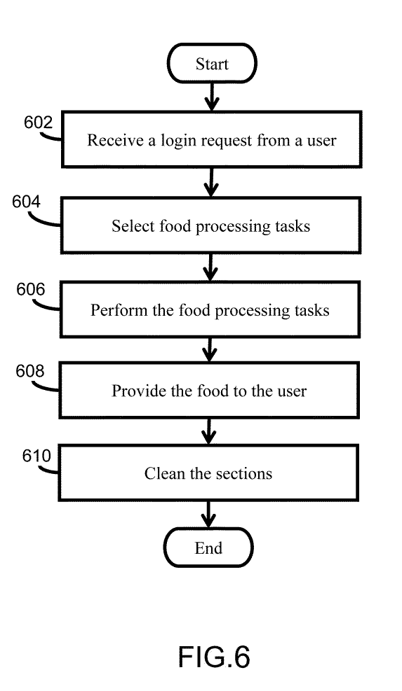

FIG. 6 is flowchart illustrating exemplary processing steps for automatic preparation of food, in accordance with an embodiment of the present invention. At step 602, the system 100 receives a login request from a user. The user then accesses the system 100 using the user interface at the display device 302. At step 604, the user selects one or more food processing tasks for preparing a food item. At step 606, the system 100 performs the one or more food processing tasks using the one or more preparation sections through the computing device 112. At step 608, the food is prepared and provided to the user. Finally, the cleaning system 110 cleans the one or more preparation sections after the completion of the food preparation at step 610.

The present invention provides a system which is able to provide high quality food to the user. The high quality food contains the one or more ingredients in a correct quantity. Further, the process can be automated or semi-automated thereby facilitating preparation of high quality food. Moreover, the user can modify the recipe according to the taste and requirements. Additionally, the user can instruct or control the system of the present invention from a remote location.

Although the foregoing invention has been described in some detail for purposes of clarity of understanding, it will be apparent that certain changes and modifications may be practiced within the scope of the claims. Accordingly, the present embodiments are to be considered as illustrative and not restrictive, and the invention is not to be limited to the details given herein, but may be modified within the scope and equivalents of the appended claims.

What is claimed is:

1. A system for automatic preparation of a meal from one or more ingredients of a plurality of ingredients, the one or more ingredients determined based on a recipe of the meal, the system comprising:
one or more preparation sections including:
a storage section, the storage section storing the plurality of ingredients;
a transportation section, the transporting section selecting and transporting the one or more ingredients of the plurality of ingredients stored in the storage section;
a cooking section, the cooking section processing the one or more ingredients received from the transportation section;
a heating section, the heating section performing heating functions for meal preparation upon receiving a requirement from the cooking section; and
a cleaning section, the cleaning section performing cleaning functions after the completion of meal preparation; and
a computing device, the computing device controlling the one or more preparation sections.

2. The system recited in claim 1, wherein the storage section comprises:
a) a refrigerated section storing a first ingredient of the plurality of ingredients, the first ingredient requiring a pre-specified preservation temperature; and
b) an unrefrigerated section storing a second ingredient of the plurality of ingredients.

3. The system recited in claim 1, wherein the transportation section comprises:
a selection module for selecting the one or more ingredients from the plurality of ingredients stored in the storage section.

4. The system recited in claim 1, wherein the cooking section performs one or more mechanical operations, the one or more mechanical operations including at least one selected from a group consisting of a cutting operation, a measuring operation, a weighing operation, an oven operation, a microwave operation and an operation of combining the one or more ingredients.

5. The system recited in claim 4, wherein the cooking section comprises a temperature check module for controlling a temperature in the heating section.

6. The system recited in claim 4, wherein the cooking section comprises a time check module.

7. The system recited in claim 1, wherein the computing device stores one or more recipes for meals, and wherein the one or more recipes are presented to the user based on a user selection of a general category, the general category including one selected from a group consisting of breakfast, lunch, dinner, snack, drink.

8. The system recited in claim 1, wherein the computing device determines the one or more ingredients based on a recipe, the recipe being selected by a user.

9. The system recited in claim 1, wherein the computing device notifies the user when the meal is prepared.

10. The system recited in claim 1, wherein the computing device stores health related information of the one or more ingredients.

11. The system recited in claim 1 further comprising:
one or more health indicator modules for measuring one or more health indicators of the user.

12. The system recited in claim 11, wherein the computing device presents the one or more recipes to the user based on the one or more health indicators of the user and the stored health related information of the one or more ingredients.

13. The system recited in claim 1, wherein the computing device comprises a display device.

14. The system recited in claim 13, wherein the display device presents the user with one or more User Interface (UI) screens.

15. The system recited in claim 1, wherein the computing device is one of a personal computer (PC), a minicomputer, a mainframe computer, a microcomputer, a telephone device or a personal digital assistant (PDA).

16. The system recited in claim 1, wherein the computing device is connected to the one or more preparation sections via one selected from a group consisting of a switched telephone connection, a cable connection and a wireless connection.

17. The system recited in claim 1, wherein the computing device accepts input through a user input device.

18. A method for automatic preparation of a meal from one or more ingredients of a plurality of ingredients, the one or more ingredients determined based on a recipe of the meal, the method comprising:
storing the plurality of ingredients in a storage section;
selecting and transporting, via a transportation section, the one or more ingredients of the plurality of ingredients stored in the storage section;
processing, at a cooking section, the one or more ingredients received from the transportation section;
performing heating functions for meal preparation upon receiving a requirement from the cooking section;
performing cleaning functions, via a cleaning section, after the completion of meal preparation; and
controlling, via a computing device, the storing, selecting, processing, performing heating functions, and performing cleaning functions.

19. The method recited in claim 18, wherein the storing further, comprises:
storing a first ingredient of the plurality of ingredients in a refrigerated section, the first ingredient requiring a pre-specified preservation temperature; and
storing a second ingredient of the plurality of ingredients in a unrefrigerated section.

20. The method recited in claim 18, wherein the selecting and transporting further comprises:
selecting, via a selection module, the one or more ingredients from the plurality of ingredients stored in the storage section.

21. The method recited in claim 18, wherein the processing further comprises:
performing one or more mechanical operations, the one or more mechanical operations including at least one selected from a group consisting of a cutting operation, a measuring operation, a weighing operation, an oven operation, a microwave operation and an operation of combining the one or more ingredients.

22. The method recited in claim 21, wherein the processing further comprises:
controlling a temperature in the heating section.

23. The method recited in claim 21, wherein the processing further comprises:
controlling a time of the heating functions.

24. The method recited in claim 18, wherein the computing device stores one or more recipes for meals, and wherein the one or more recipes are presented to the user based on a user selection of a general category, the general category including one selected from a group consisting of breakfast, lunch, dinner, snack, drink.

25. The method recited in claim 18, wherein the computing device determines the one or more ingredients based on a recipe, the recipe being selected by a user.

26. The method recited in claim 18, further comprising:
storing, at the computing device, health related information of the one or more ingredients.

27. The method recited in claim 18, further comprising:
measuring, via one or more health indicator modules, one or more health indicators of the user.

28. The method recited in claim 27, further comprising:
presenting, via the computing device, the one or more recipes to the user based on the one or more health indicators of the user and the stored health related information of the one or more ingredients.

29. A computer program product for use with a computer, the computer program product comprising a computer usable medium having a computer readable program code stored thereon for performing automatic preparation of a meal from one or more ingredients of a plurality of ingredients, the one or more ingredients determined based on a recipe of the meal, the computer program product performing the steps of:
storing the plurality of ingredients in a storage section;
selecting and transporting, via a transportation section, the one or more ingredients of the plurality of ingredients stored in the storage section;
processing, at a cooking section, the one or more ingredients received from the transportation section;
performing heating functions for meal preparation upon receiving a requirement from the cooking section;
performing cleaning functions, via a cleaning section, after the completion of meal preparation; and
controlling, via a computing device, the storing, selecting, processing, performing heating functions, and performing cleaning functions.
